(19) United States
(12) Patent Application Publication
(10) Pub. No.: US 2012/0287140 A1
(43) Pub. Date: Nov. 15, 2012

(54) Display Interface Circuit

(76) Inventors: Ming-Chieh Lin, Hsinchu County (TW); Ying-Yu Kuo, Hsinchu City (TW); Wei-Ying Tu, Hsinchu City (TW)

(21) Appl. No.: 13/420,587

(22) Filed: Mar. 14, 2012

(30) Foreign Application Priority Data
May 13, 2011 (TW) 100116804

(51) Int. Cl. G09G 3/36; G06F 13/14

(52) U.S. Cl. 345/520; 345/87

(57) ABSTRACT

A display interface circuit includes a physical layer circuit for receiving and modulating an original data signal and an original clock signal, a frame buffer for storing and outputting the data signal according to the clock signal and a command signal, a display serial interface for transmitting the data signal and the clock signal through packetization, a configuration register for generating the command signal according to an asynchronous clock signal and the data signal, and an asynchronous delay circuit for adjusting a clock latency that the clock signal takes to be sent to the configuration register to generate the asynchronous clock signal.

### BACKGROUND OF THE INVENTION

1. Field of the Invention

The present invention relates to a display interface circuit, and more particularly, to a display interface circuit capable of adjusting a clock latency via an asynchronous flip-flop circuit.

2. Description of the Prior Art

With the advancement of technology, more and more communication and display technologies are now integrated into hand-held devices such as smart phones, Personal Digital Assistants (PDA), etc., to implement various application functionalities. In order to simultaneously control the various functionalities, a high-speed processing interface between a processor and a display panel of a smart hand-held device is required to increase data throughput, so as to enhance display quality or functionalities such as touch control. To this end, a Mobile Industry Processor Interface (MIPI) has been proposed in the industry to standardize the processing interface in hand-held devices.

Please refer to FIG. 1, which is a schematic diagram of an MIPI 10 according to the prior art. In FIG. 1, the MIPI 10 utilizes high-speed transmission to transmit an original data signal DAT_o and an original clock signal CLK_o provided by a processor 112 of a mobile phone to a display panel 110 of the mobile phone. The MIPI 10 includes a physical layer circuit 100, a display serial interface (DSI) 102, a memory controller 104, a configuration register 106, and a frame buffer 108. The physical layer circuit 100 modulates the original data signal DAT_o and the original clock signal CLK_o according to MIPI specifications, and respectively generates a data signal DAT and a clock signal CLK accordingly. The DSI 102 transmits the data signal DAT and the clock signal CLK through packetization. The memory controller 104 generates an access signal ACC according to the data signal DAT and the clock signal CLK, to control an access of the frame buffer 108. The configuration register 106 generates a command signal CMD according to the clock signal CLK and the data signal DAT, to control an output of the frame buffer 108 to the display panel 110. The frame buffer 108 temporarily stores the data signal DAT, so as to output the data signal DAT to the display panel 110 when the mobile phone is refreshing frames.

Note that, in the MIPI 10, the physical layer circuit 100 is an analog circuit, whereas the display serial interface 102, the memory controller 104, and the configuration register 106 are digital circuits. This poses particular difficulties for performing clock distribution in the MIPI 10. Generally, circuit designers perform clock distribution via Clock Tree Synthesis (CTS) techniques to reduce clock skew between different components of the MIPI 10, but this does not guarantee a reduction in clock latency. For example, please refer to FIG. 2A, which is a timing diagram of a clock signal CLK in different regions of the MIPI 10 after CTS. In FIG. 2A, CLK_a is a timing diagram when the clock signal CLK starts from the physical layer circuit 100, and CLK_b is a timing diagram when the clock signal CLK reaches the display serial interface 102. A timing difference of between the CLK_an and the CLK_b is a clock latency LTC. However, as the clock signal CLK increases in clock rate to accommodate high speed transmission requirements, the clock latency LTC may result in a hold time violation in the CLK_b, as shown in FIG. 2B, causing the MIPI 10 malfunction.

Therefore, how to maintain a normal operation of the clock signal for MIPI when analog and digital circuits coexist has become a common goal for the industry.

### SUMMARY OF THE INVENTION

Therefore, a primary objective of the present invention is to provide a display interface circuit.

A display interface circuit for coordinating a processor and a display panel of a mobile device is disclosed. The interface circuit comprises an analog circuit module, comprising a physical layer circuit, for receiving and modulating an original data signal and an original clock signal provided by the processor, and respectively generating a data signal and a clock signal accordingly, to conform to an industry specification; a frame buffer, for storing the data signal according to an access signal and the clock signal, and for outputting the data signal to the display panel according to a command signal; and a digital circuit module, comprising a display serial interface (DSI), coupled to the physical layer circuit, for transmitting the data signal and the clock signal through packetization; a memory controller, coupled between the display serial interface and the frame buffer, for generating the access signal according to the data signal and the clock signal; a configuration register, for generating the command signal according to an asynchronous clock signal and the data signal; and an asynchronous delay circuit, coupled between the display serial interface and the configuration register, for adjusting a clock latency taken for the clock signal to be sent to the configuration register, to generate the asynchronous clock signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a Mobile Industry Processor Interface (MIPI) according to the prior art.

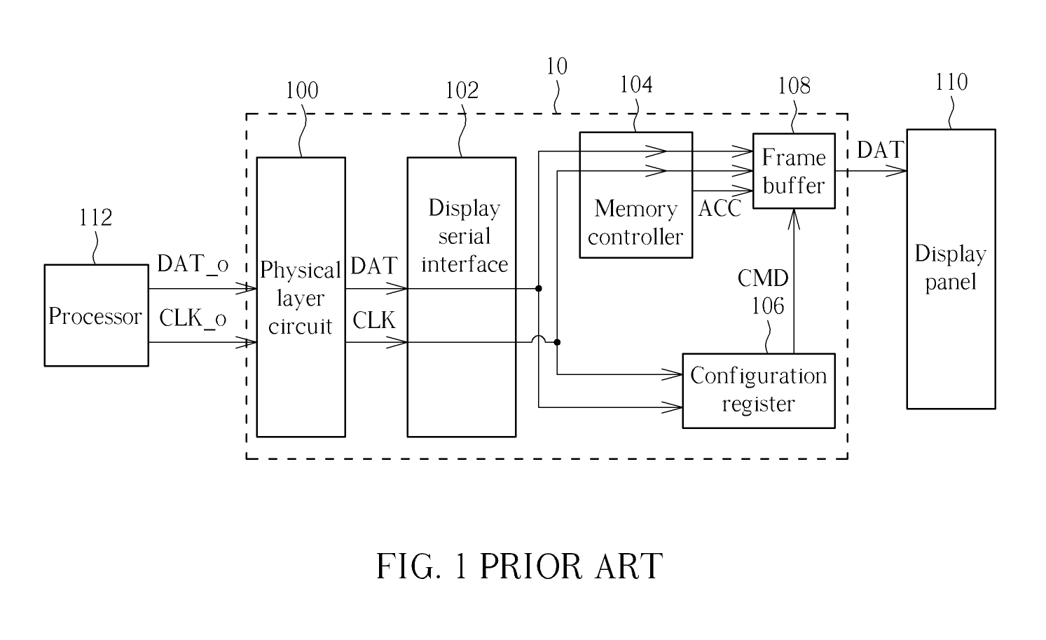

FIGS. 2A and 2B are timing diagrams a clock signal indifferent regions of the MIPI shown in FIG. 1, after clock tree synthesis (CTS).

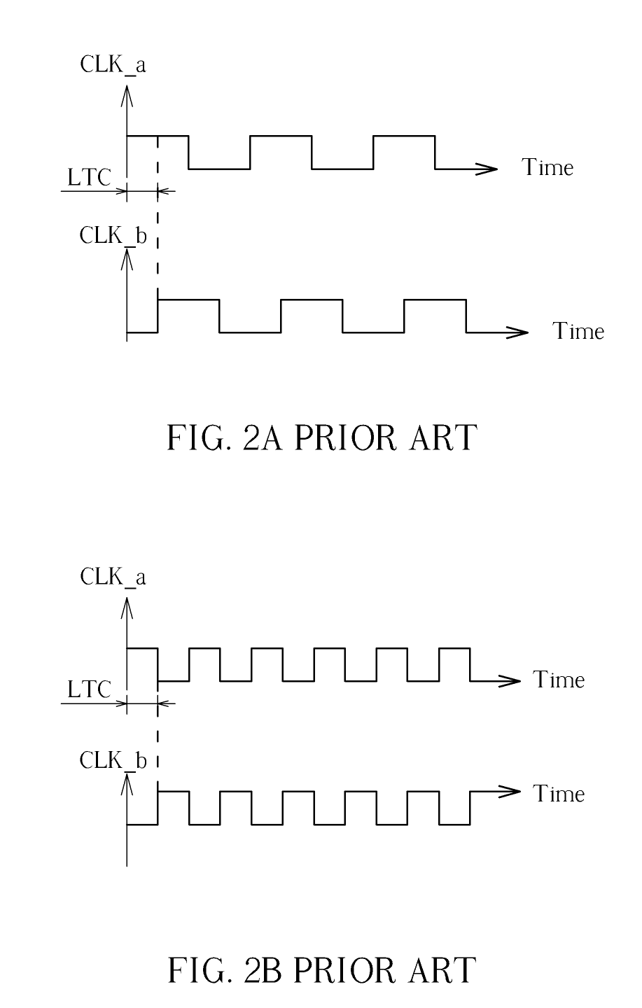

FIG. 3 is a schematic diagram of an MIPI.

FIG. 4 is a timing diagram of an original data signal and an original clock signal of the MIPI shown in FIG. 3.

FIG. 5 is a schematic diagram of a MIPI according to an embodiment of the invention.

### DETAILED DESCRIPTION

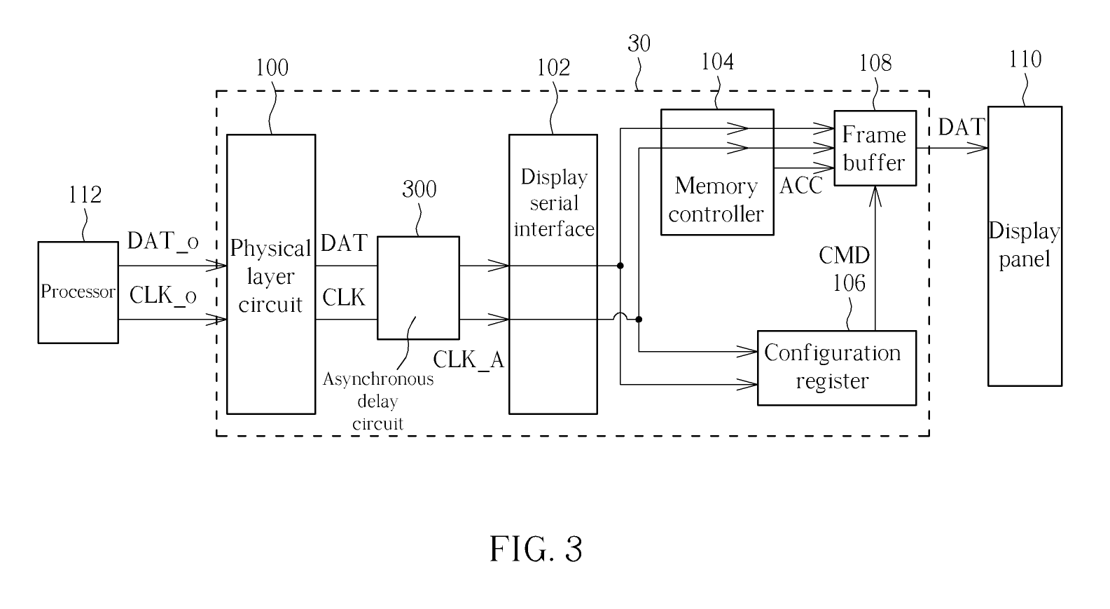

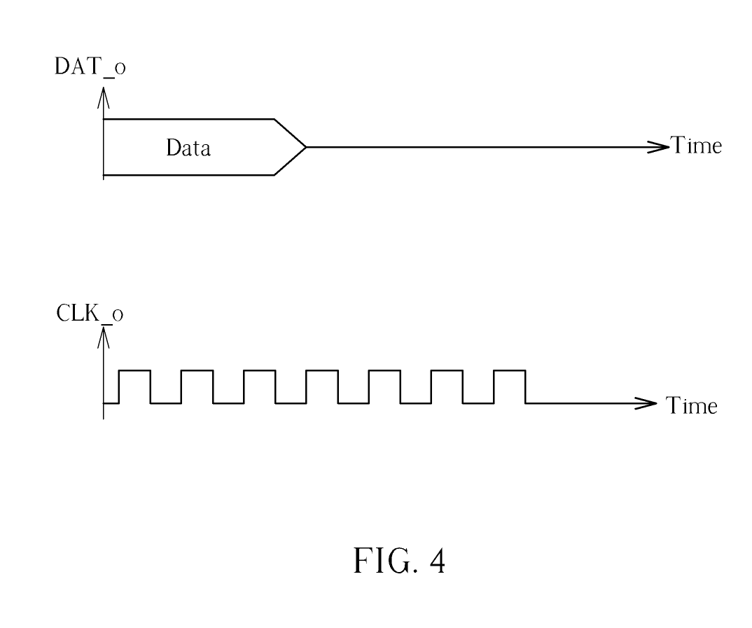

Please refer to FIG. 3, which is a schematic diagram of a Mobile Industry Processor Interface (MIPI) 30. The MIPI 30 is added with an asynchronous delay circuit 300 between the physical layer circuit 100 and the Display Serial Interface (DSI) 102 of the MIPI 10, for delaying a timing taken for the clock signal CLK to reach the display serial interface 102, so as to ensure that setup time and hold time requirements are met. However, insertion of the asynchronous delay circuit 300 has a side effect of increasing an overall clock latency for the MIPI 30. In other words, a time required for the clock signal CLK to be propagated to a terminal component (e.g. the configuration register 106 and the frame buffer 108) increases. Generally, to save power, if the processor 112 ceases to output the original data signal DAT_o, the original clock signal CLK_o would also stop after several clock periods, as shown in FIG. 4. In such a case, since the clock signal CLK is delayed by the asynchronous delay circuit 300, when the data signal DAT reaches the frame buffer 108, the clock signal CLK would already have stopped, causing the data signal DAT to fail to be correctly written into the frame buffer 108.

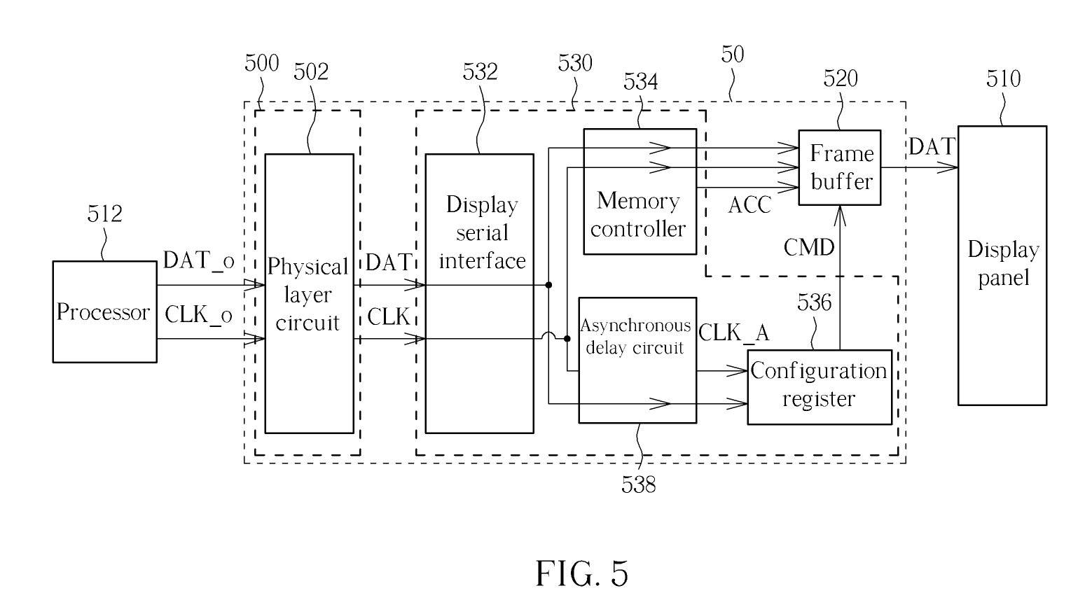

To overcome the side-effect of the asynchronous delay circuit 300, please refer to FIG. 5, which is a schematic diagram of an MIPI 50 according to an embodiment of the invention. The MIPI 50 coordinates a processor 512 and a display panel 510 of a mobile device. The MIPI 50 includes an analog circuit module 500, a frame buffer 520, and a digital circuit module 530. The analog circuit module 500 includes a physical layer circuit 502, for receiving and modulating an original data signal DAT_o and an original clock signal CLK_o provided by the processor 512 according to MIPI standards, and respectively generating a data signal DAT and a clock signal CLK accordingly. The frame buffer 520 stores the data signal DAT according to an access signal ACC and the clock signal CLK, and outputs the data signal DAT to the display panel 510 according to a command signal CMD. The digital circuit module 530 includes a display serial interface 532, a memory controller 534, a configuration register 536, and an asynchronous delay circuit 538. The display serial interface transmits the data signal DAT and the clock signal CLK through packetization. The memory controller 534 generates the access signal ACC according to the DAT data signal and the CLK clock signal. The configuration register 536 generates the command signal CMD according to an asynchronous clock signal CLK_A and the data signal DAT. The asynchronous delay circuit 538 adjusts a clock latency taken for the clock signal CLK to be sent to the configuration register 536, to generate the asynchronous clock signal CLK_A.

In short, to prevent the clock signal CLK from stopping before the data signal DAT reaches the frame buffer 520, the asynchronous delay circuit 538 is coupled between the display serial interface 532 and the configuration register 536, instead. As such, compared with the MIPI 30, the latency taken for the clock signal CLK to be sent to the frame buffer 520 can be shortened, thus guaranteeing a normal operation of the frame buffer 520. Since the configuration register 536 includes numerous flip-flops, which is not conducive for Clock Tree Synthesis (CTS), the asynchronous delay circuit 538 is required to adjust the time latency to prevent a violation of setup time or hold time of the clock signal. Comparatively, the frame buffer 520 includes fewer flip-flops, and thus an additional asynchronous delay circuit is unnecessary.

Preferably, the asynchronous delay circuit 538 may be implemented via serially connected flip-flops, but this is not limited to this. Furthermore, more practically, if the mobile device is a mobile phone, and the display panel 510 is a thin-film transistor liquid-crystal display (TFT-LCD) panel, the data signal DAT would include source driving signals and gate driving signals required for refreshing the display content.

In the prior art, as the clock rate of the clock signal CLK gradually increases, the occurrence of setup time/hold time violation due to clock latency becomes more probable in the clock signal CLK, which cannot be solved by conventional clock tree synthesis techniques. Despite that setup time/hold time violation in the clock signal CLK is solved by adding the additional asynchronous delay circuit 300 in the MIPI 30, this raises further issues in that the frame buffer 108 would fail to operate normally after the clock signal CLK stops. Comparatively, the invention adjusts the latency for the clock signal CLK to be sent to the configuration register 536 via the asynchronous delay circuit 538 only, as per requirements for different latency adjustments in the clock signal CLK of the configuration register 536 and the frame buffer 520. As such, before the frame buffer 520 completes writing the data signal DAT, the clock signal CLK would remain oscillating, thus ensuring normal operation of the MIPI 50.

In summary, the invention adds an additional asynchronous delay circuit between the display serial interface and the configuration register only, thus fulfilling both the power-saving requirement to stop the clock signal, as well as the clock latency adjustment requirement of the MIPI.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display interface circuit for coordinating a processor and a display panel of a mobile device, the interface circuit comprising:
an analog circuit module, comprising a physical layer circuit, for receiving and modulating an original data signal and an original clock signal provided by the processor, and respectively generating a data signal and a clock signal accordingly, to conform to an industry specification;
a frame buffer, for storing the data signal according to an access signal and the clock signal, and outputting the data signal to the display panel according to a command signal; and
a digital circuit module, comprising:
a display serial interface (DSI), coupled to the physical layer circuit, for transmitting the data signal and the clock signal through packetization;
a memory controller, coupled between the display serial interface and the frame buffer, for generating the access signal according to the data signal and the clock signal;
a configuration register, for generating the command signal according to an asynchronous clock signal and the data signal; and
an asynchronous delay circuit, coupled between the display serial interface and the configuration register, for adjusting a clock latency taken for the clock signal to be sent to the configuration register, to generate the asynchronous clock signal.

2. The display interface circuit of claim 1, wherein the original clock signal stops after the original data signal remains stationary for a duration of a post-processing time.

3. The display interface circuit of claim 2, wherein the frame buffer stores the data signal before the clock signal stops with the original clock signal.

4. The display interface circuit of claim 1, wherein the asynchronous delay circuit comprises at least one flip-flop.

5. The display interface circuit of claim 1, wherein the industry specification is a Mobile Industry Processor Interface (MIPI).

6. The display interface circuit of claim 1, wherein the display panel is a thin-film transistor liquid-crystal display (TFT-LCD) panel.

7. The display interface circuit of claim 6, wherein the data signal comprises a plurality of source driving signals and a plurality of gate driving signals.
